(19) United States
(12) Patent Application Publication
(10) Pub. No.: US 2014/0161031 A1
(43) Pub. Date: Jun. 12, 2014

(54) BLUETOOTH VOICE QUALITY IMPROVEMENT

(71) Applicant: BROADCOM CORPORATION, Irvine, CA (US)

(72) Inventors: Norbert Grunert, Antibes (FR); Prasanna Desai, Elfin Forest, CA (US)

(73) Assignee: Broadcom Corporation, Irvine, CA (US)

(21) Appl. No.: 13/853,362

(22) Filed: Mar. 29, 2013

Related U.S. Application Data
(60) Provisional application No. 61/734,335, filed on Dec. 6, 2012.
(60) Provisional application No. 61/804,981, filed on Mar. 25, 2013.

(51) Int. Cl. H04L 5/00

(52) U.S. Cl. CPC H04L 5/0044
USPC 370/328

(57) ABSTRACT

Various examples are provided for related to Bluetooth voice quality improvement. In one example, among others, a method includes determining whether a packet payload is received during a transmission period of a collocated interface based at least in part upon signaling from the collocated interface and replacing at least a portion of the payload with estimated payload data based at least in part upon whether the payload was received during the transmission period. In another example, a communication device includes a first interface that supports BT communications and a collocated second interface. The first interface is operable to replace at least a portion of a payload of a BT packet with estimated payload data based at least in part upon signaling from the second interface that indicates whether at least a portion of the BT packet was received during a transmission period of the second interface.

### CROSS REFERENCE TO RELATED APPLICATIONS

This application claims priority to co-pending U.S. provisional application entitled “BLUETOOTH VOICE QUALITY IMPROVEMENT TECHNIQUES IN INTERFERENCE SCENARIOS” having Ser. No. 61/734,335, filed Dec. 6, 2012, and to co-pending U.S. provisional application entitled “BLUETOOTH VOICE QUALITY IMPROVEMENT” having Ser. No. 61/804,981, filed Mar. 25, 2013, both of which are hereby incorporated by reference in their entirety.

### BACKGROUND

Communication systems typically operate in accordance with one or more communication standards. Wireless communication systems may operate in accordance with one or more standards including, but not limited to, Institute of Electrical and Electronics Engineers (IEEE) 802.11, Wi-Fi Direct, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof. Radio frequency (RF) signals of the wireless communication systems are transmitted over a wide range of frequencies. RF signals are communicated in frequency ranges defined for the different communication standards.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1-3 are graphical representations illustrating examples of coexisting cellular (e.g., LTE) and wireless (e.g., Bluetooth) communications in accordance with various embodiments of the present disclosure.

FIG. 4 is a graphical representation of an example of a communication device in accordance with various embodiments of the present disclosure.

FIG. 5 is a plot illustrating the relationship between bit error rate (BER) and packet loss rate (PLR) for various BT communications of FIG. 2 in accordance with various embodiments of the present disclosure.

FIG. 6 is a plot illustrating the relationship between bit error rate (BER) and perceptual evaluation of speech quality (PESQ) for various LTE frame configurations of FIG. 2 in accordance with various embodiments of the present disclosure.

FIG. 7 is a flowchart illustrating an example of collision correction for coexisting interfaces (or devices) in accordance with various embodiments of the present disclosure.

FIG. 8 is a schematic block diagram illustrating an example of a communication device in accordance with various embodiments of the present disclosure.

### DETAILED DESCRIPTION

Disclosed herein are various embodiments that are related to Bluetooth voice quality improvement. Transmission and reception patterns of collocated cellular (e.g., long term evolution (LTE)), Bluetooth (BT), wireless local area network (WLAN), and/or other wireless communication interfaces (or devices) can result in interference between coexisting communications. For example, LTE communications can occur in band 7 and/or band 40, which are both adjacent to BT and WLAN communication bands. Collisions can occur when an interface (or device) receives a packet while another collocated interface (or device) is transmitting. Collisions may produce one or more bit errors in the received packet data. If the LTE transmissions are close to the BT or WLAN band when receiving BT and/or WLAN packets, then collisions can occur which may result in corrupted data and packet loss. Similarly, WLAN (or WiFi) transmissions may collide with BT receptions. Sufficient corruption of the packet data can adversely affect the reconstructed data. In the case of voice communications, corruption of the packet payload can result in degradation of the reproduced audio by, e.g., crackling (pop-corn noise) and/or static noise.

Bulk acoustic wave (BAW) filters may be used to reduce some of the interference between collocated interfaces (or devices). For example, a BAW filter can be used to mitigate interference from BT transmissions on LTE packet reception. Adaptive frequency hopping (AFH) may also be used to avoid BT interference with LTE or other collocated interface (or device). Even with a BAW filter, the higher transmit power of LTE may still result in interference with BT signals. For instance, LTE transmissions in, e.g., band 7, band 40 and/or band 41 may result in increased background noise levels and desensitization of the collocated BT interface (or device). In some cases, the LTE transmit (TX) power may be at a lower level (e.g., when the LTE interface is close to a base station or eNodeB) for transmissions in the adjacent bands to reduce potential interference. The power level could be adjusted to maintain reliable LTE communications between the interface (or device) and base station. Temperature shifts of the filters during operation of the collocated interfaces (or devices) can also result in an increased sensitivity to coexisting LTE transmissions that adds to the desensitization of the BT interface. The BT interface may experience similar interference from coexisting WLAN (or WiFi) transmissions or other coexisting RF transmissions (e.g., worldwide interoperability for microwave access (WiMax).

BT communications can use high quality voice packets (e.g., HV1, HV2, and HV3 packets), extended synchronous connection oriented (eSCO) packets, or other types of BT packets for voice communications. Corruption of the payload of BT voice packets can result in degradation of the reproduced audio by, e.g., crackling (pop-corn noise) and/or static noise. For example, BT HV3 packets are commonly used for voice. However, the 3.75 ms periodicity of the BT HV3 packets does not align with the 10 ms LTE frame period. Hence unavoidable collisions can occur causing collocated LTE transmissions to corrupt concurrently received BT bits, which can result in poor audio quality on a BT device such as, e.g., a headset or a BT enabled audio system in a car (e.g., through a car kit). Because of the mismatch in BT and LTE periodicity, scheduling to avoid receiving BT packets during an LTE transmit (TX) periods can be difficult. However, the timing of the collocated interfaces (or devices) may be synchronized to reduce and/or minimize collisions.

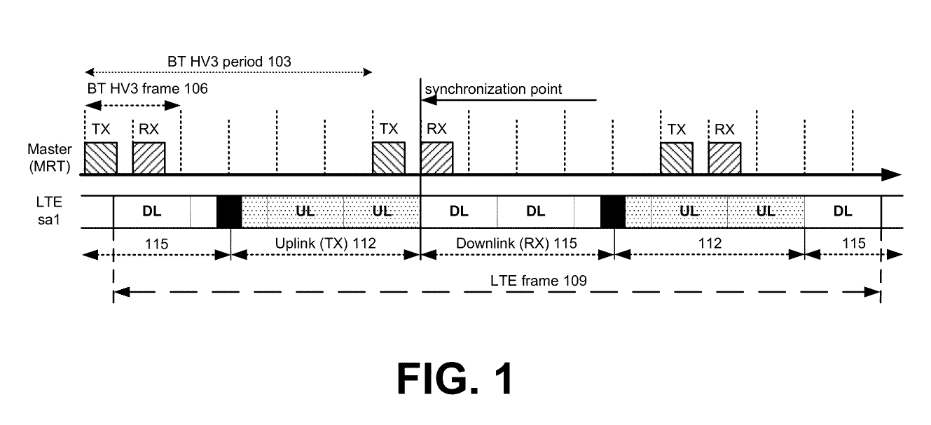

Referring to FIG. 1, shown is an example of the relationship between BT and LTE communications. In FIG. 1, the BT 103 period includes an initial 1.25 ms HV3 frame 106 with a BT transmit (TX) slot and a BT receive (RX) slot, followed by two additional frames including TX and RX slots for retransmission of packets. The LTE frame 109 includes ten 1 ms subframes which can be designated as an uplink (UL) subframe, a downlink (DL) subframe, or a special (S) subframe including an UL pilot time slot and a DL pilot time slot with an intermediate guard period. LTE TX occurs during UL periods 112 and LTE RX occurs during DL periods 115. Various LTE frame configurations may be used to specify the allocation of the DL, UL, and S subframes.

Pure time-division multiplexing (TDM) scheduling can be used to prevent LTE TX/BT RX and LTE RX/BT TX collisions between collocated interfaces (or devices). A hybrid TDM mode may also be used where the BAW filter rejection and lower BT TX power is sufficient to reduce the impact of concurrent BT TX on LTE RX to an acceptable bit error level. Thus, the BT packet scheduler only needs to avoid collocated LTE TX from occurring with concurrent BT RX. BT packet loss from collisions can occur with a BT RX during a LTE UL period 112. The BT RX may be synchronized with the LTE RX to reduce or minimize the chance of collisions. While LTE transmissions may not occur during every UL subframe, such an assumption allows a worst case analysis.

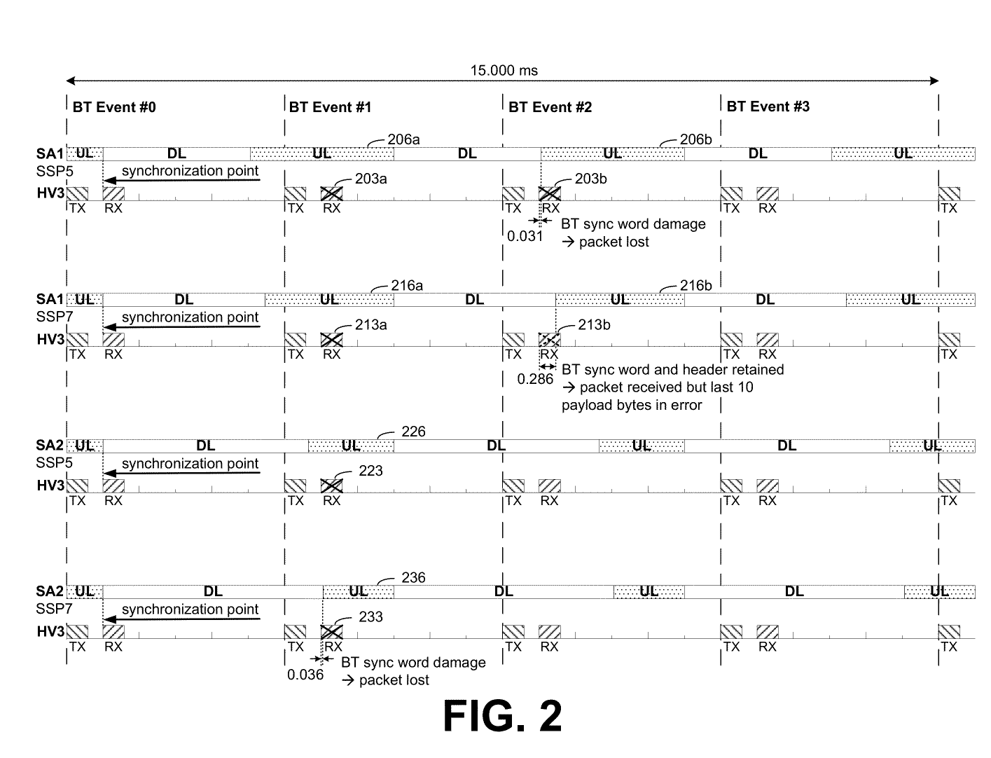

Referring to FIG. 2, shown are examples of the relationship between BT HV3 communications and LTE communications using frame configurations such as, e.g., subframe assignment SA1 or SA2 with special subframe pattern SSP5 or SSP7. Depending on which LTE frame configuration is used (e.g., SA1-SSP5, SA1-SSP7, SA2-SSP5 or SA2-SSP7), synchronization of the BT RX slot of the initial HV3 frame with the beginning of a LTE DL period produces different packet loss rates (PLR) for the various LTE frame configurations. The possibility of collisions between BT RX and collocated LTE TX are deterministic and periodic. FIG. 2 illustrates a periodicity of 15 ms or four BT SCO events.

In the case of SA1-SSP5, collisions can occur during two of the four BT SCO events. HV3 packets can be lost during two of the BT RX 203a and 203b because of bit errors in the packet synch word, header, and/or payload induced by collisions during LTE UL periods, which would result in a PLR of 50%. BT HV3 RX 203a falls completely within the LTE UL period 206a, which can result in detectable errors in the packet synch word and/or header as well as errors in the payload that would not be detected by the collocated BT interface (or device) receiving the packet. While the LTE UL period 206b begins 0.031 ms after the beginning of the BT HV3 RX 203b, bit errors can be produced in the packet synch word and/or header that could be detected by the BT interface. When the synch word and/or header is corrupted by a coexisting LTE TX, the packet payload can be discarded and replaced by an estimate (or prediction) of the discarded payload data generated by, e.g., packet loss concealment (PLC) algorithms to mitigate some of the effects on the reproduced voice signal.

In the case of SA1-SSP7, collisions can occur during two of the four BT SCO events. BT HV3 RX 213a falls completely within the LTE UL period 216a, which can result in detectable errors in the packet header as well as errors in the payload that would not be detected by the collocated BT interface (or device) receiving the packet. In contrast, only the end of BT HV3 RX 213b falls within the LTE UL period 216b. In this situation, the LTE TX would not occur while the packet synch word and header are received by the BT interface, but collisions would occur while the last third of the packet payload is being received. This can result in bit errors in the packet payload that would not be detected by the receiving BT interface (or device). The packet would be received as good because the errors would not be detected, resulting in a PLR of 25%. However, bit errors in the packet payload would result in degradation of the reproduced audio output that would be apparent to the listener. While detectable corruption of BT HV3 RX 213a would result in the payload data being discarded and replaced to mitigate the audio effects, any payload data corrupted during the end of BT HV3 RX 213b would not be detected and thus would remain unchanged.

In the cases of SA2-SSP5 and SA2-SSP7, collisions can occur during two one the four BT SCO events. For SA2-SSP5 the BT HV3 RX 223 falls completely within the LTE UL period 226, which can result in detectable errors in the packet header as well as errors in the payload that would not be detected by the BT interface (or device) receiving the packet. For SA2-SSP7 the LTE UL period 236 begins 0.036 ms after the beginning of the BT HV3 RX 233, which can produce bit errors in the packet synch word and/or header that could be detected. Packet corruption of BT HV3 RX 223 and BT HV3 RX 233 would result in a PLR of 25%. The corrupted payload data can be discarded and replaced to mitigate the effects on the reproduced audio output.

Replacement of corrupted packet payload data using, e.g., PLC can compensate for some of the packet loss effects. The effect on the quality of the reproduced voice signal may be quantified by determining, e.g., the perceptual evaluation of speech quality (PESQ) of the audio output. PESQ is a family of standards including test methodologies that determines a score assessing the speech quality on a scale from 1 (bad) to 5 (excellent). A score of about 4 is considered good, while a score of 3 or less indicates discernible degradation that can be improved. A score of about 2 is considered a bad audio signal.

The effects on a voice signal communicated using HV3 packets were examined for the examples of FIG. 2. The original audio signal had a PESQ of 3.91. In the case of SA1-SSP5, the reproduced audio output had a PESQ of 2.16. The reproduced voice signal exhibited strong “robotic” speech artifacts from the effort to reconstruct every other 7.5 ms speech period using PLC. In the case of SA1-SSP7, the reproduced audio output was heavily impaired by the bit errors in the last 10-byte payload portion of the packet, which was corrupted by collisions during BT HV3 RX 213b. When the packet header was correctly received, the PLC was not used to replace the corrupted payload. The PESQ was 2.05, indicating that replacement of the corrupted payload may improve the quality of the reproduced voice. In the cases of SA2-SSP5 and SA2-SSP7, replacement of one in four packets resulted in the PESQ was 3.03.

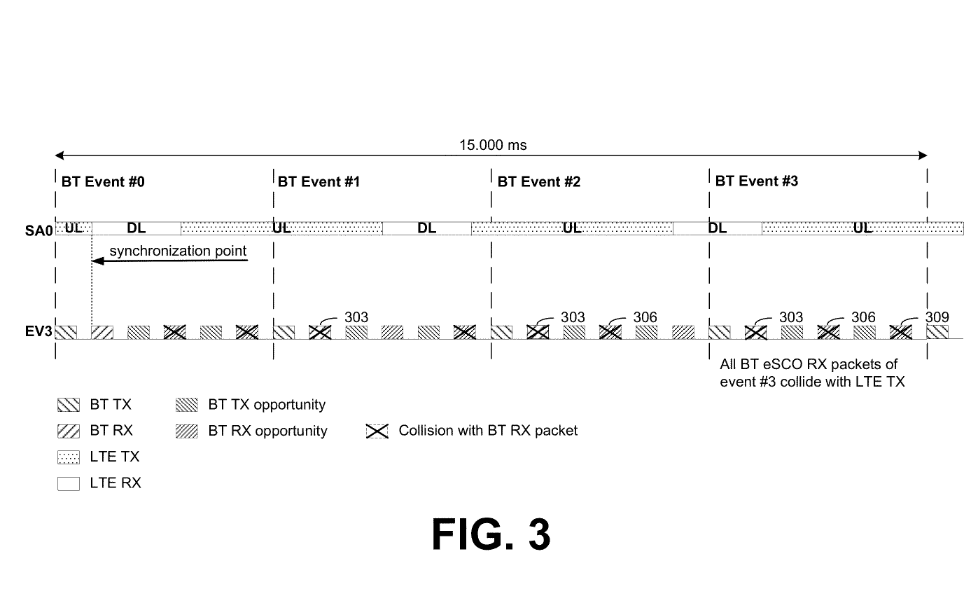

BT communications using eSCO packets may avoid many of the problems of HV3. The BT eSCO RX may be synchronized with the LTE DL periods to reduce or minimize the chance of collisions. However, eSCO combinations still exist where collisions are unavoidable, resulting in corruption of the BT data. Referring to FIG. 3, shown is an example of the relationship between BT EV3 communications and LTE communications using frame configuration subframe assignment SA0 with special subframe pattern SSPO and a periodicity of 15 ms or four BT eSCO events. The BT interface (or device) may be a collocated BT master communicating voice using EV3 packets over, e.g., a 64 kbps voice link. In other instances, the BT interface (or device) may be a collocated BT slave. When operating in a hybrid mode with BAW filters, collisions between LTE TX and BT RX are deterministic and periodic.

As can be seen from FIG. 3, the number of BT retransmissions that are allowed during a BT period affects the PLR. If no repetitions are allowed, then collisions can occur during three of the four initial frames of the BT eSCO events. This results in impairment of three of the four EV3 packets or a PLR of 75%. If one repetition (or retransmission) is allowed during the next BT frame, then impairment due to collisions can occur during two of the retransmissions at BT RX 306. This reduces the PLR to 50%. If two repetitions (or retransmissions) are allowed, then impairment can be reduced to the retransmission at BT RX 309, further reducing the PLR to 25%. While BT eSCO packet payloads include cyclic redundancy check (CRC) error detection, which may be used to determine whether bit errors are present, unavoidable collisions can occur during the BT RX of the last frame of BT eSCO event #3. For example, in the presence of a LTE TX that produces a high bit error rate (BER) in a packet received during a concurrent BT RX, the CRC may have a limited error detection capability. In some cases, the high BER may allow the CRC check to pass even though the packet payload data is impaired. While many legacy applications do not support the use of eSCO, the collision correction of this disclosure may be equally applicable to BT communications with eSCO packets or other types of BT packets used for voice communications. The collision correction may also be applied to other coexisting communication devices (e.g., WiMax or WLAN) that interfere with or desensitize the BT device in a known pattern.

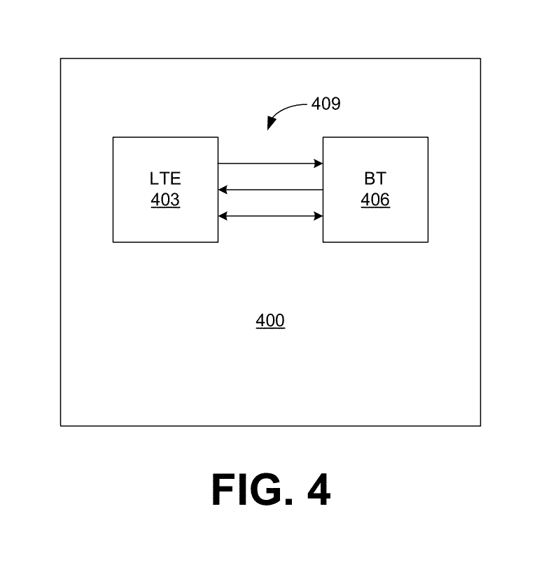

Referring to FIG. 4, shown is an example of a communication device (or platform) 400 such as, e.g., a smart phone, tablet, personal digital assistant, or other computing device that includes a cellular interface (or device) such as, e.g., LTE interface 403 collocated with a BT interface (or device) 406. The cellular interface (or device) can include processing circuitry capable of supporting cellular communications such as, e.g., LTE, 2G, 3G, 4G, or other cellular communication protocols. For example, the LTE interface 403 may include processing circuitry for one or more cellular transceiver(s) to support LTE communications. The BT interface (or device) 406 may include processing circuitry for one or more transceiver(s) to support BT communications. The communication device 400 may also include additional and/or combined interfaces (or devices) including processing circuitry to support other wireless communications such as, e.g., WLAN, WiMAX, global positioning system (GPS), near field communication (NFC), etc.

In various embodiments, the processing circuitry is implemented as at least a portion of a microprocessor. The processing circuitry may be implemented using one or more circuits, one or more microprocessors, application specific integrated circuits, dedicated hardware, digital signal processors, microcomputers, central processing units, field programmable gate arrays, programmable logic devices, state machines, or any combination thereof. In yet other embodiments, the processing circuitry may include one or more software modules executable within one or more processing circuits. The processing circuitry may further include memory configured to store instructions and/or code that causes the processing circuitry to execute data communication functions.

High speed signaling 409 is provided between the LTE and BT interfaces (or devices) 403 and 406. Signaling may also be provided between the other interfaces (or devices) to allow for communications. Examples of the high speed signaling include an LTE frame synchronization (frame_synch) signal that indicates the frame synchronization with the base station, an LTE transmit (TX) signal that indicates when the LTE interface 403 is or will be transmitting, LTE frame configuration information (e.g., config 0, config 1, config 2, etc.), and other signals and/or information. In some embodiments, the LTE and BT interfaces 403 and 406 may communicate with each other through, e.g., a two-wire bit pipe interface. The bit pipe interface may be a two-wire high speed universal asynchronous receiver/transmitter (HS_UART) with a baud rate of, e.g., 4 Mbps. Temperature and other operational conditions may also be communicated between the LTE and BT interfaces.

By knowing which LTE frame configuration being used and the LTE frame synchronization, the possibility of collisions between BT RX and collocated LTE TX are deterministic and periodic. In some embodiments, the transmission power of the LTE interface (or device) 403 may be reduced during an LTE UL period to lower the bit error rate (BER) of BT packets that are received during the LTE UL period. For example, a 3 dB reduction may be possible whet the LTE interface 403 is operating close to a base station. The BT interface 406 may send a request to the LTE interface 403 requesting a reduction in power during a specified time period. The request may specify, e.g., a time period based upon the LTE frame synchronization, corresponding to a LTE UL period, or corresponding to a BT frame or period. The request may also indicate a requested power reduction. The reduced LTE TX power may allow the BT interface to receive packets during that time period with a lower BER. If the operational conditions permit, the LTE interface 403 may reduce the TX power as requested or may adjust the TX power to a level that does not impede LTE communications. The LTE interface may confirm the reduction or adjustment to the BT interface.

Even with a reduction in LTE TX power, collisions can still result in bit errors that affect the packet header and/or payload data. When the header data of a BT packet is corrupted by a coexisting LTE TX during UL, the packet payload can discarded and replaced by an estimate of the discarded payload data. For example, PLC algorithms may be used to generate an estimate of the discarded data (or a prediction of the speech). While not perfect, the estimated data allows the audio quality to be maintained at a higher level by avoiding discontinuities in the audio output. However, packets may still be received even though they are impacted by interference causing bit errors.

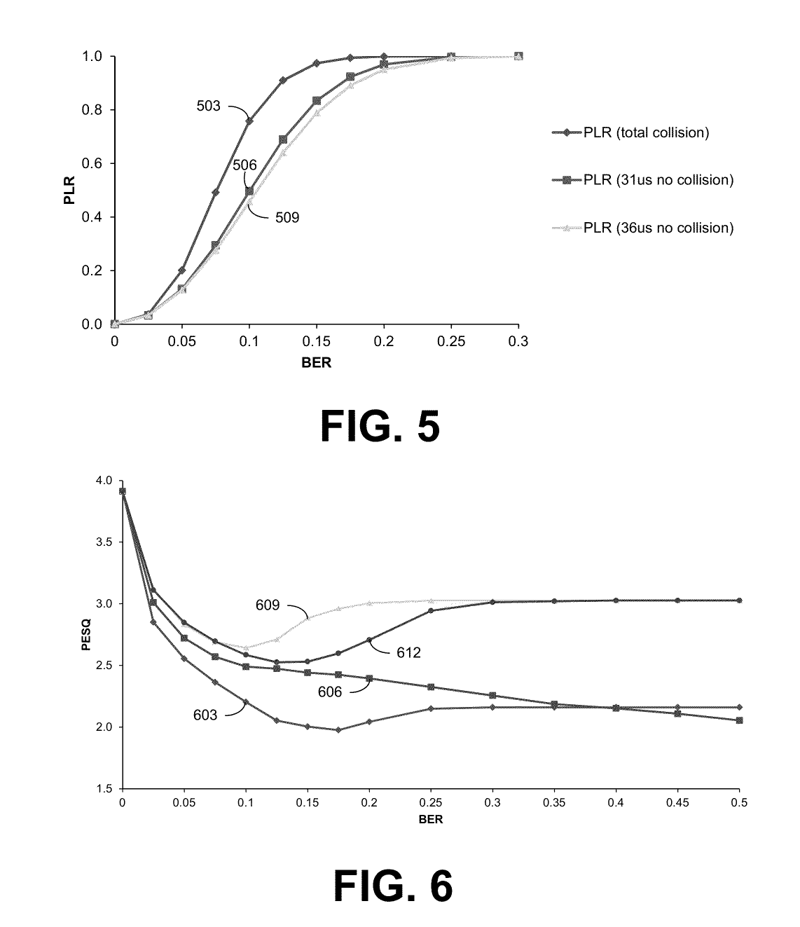

Referring to FIG. 5, shown is an example of the relationship between BER and PLR for BT HV3 packets. Even with an increased BER there is a probability that a corrupted packet is used to produce the audio output. For example, even with a BER of 10%, there is a certain probability that a HV3 packet is not lost. Assuming that the entire HV3 packet was received during a LTE UL (e.g., BT HV3 RX 203a of FIG. 2), there is about a 75% chance of detection as a lost packet as shown by curve 503. Thus, in about 25% of the cases a HV3 packet with corrupted payload data is still received. The chance of receiving HV3 packets with corrupted payload data is increased (as illustrated by curves 506 and 509) when a portion of the packet sync word and/or header is received before the LTE UL begins. Curve 506 corresponds to the condition illustrated by BT HV3 RX 203b of FIG. 2 and curve 509 corresponds to the condition illustrated by BT HV3 RX 233 of FIG. 2. Thus, even though bit errors in the packet header may be used to detect corrupted HV3 packets, it does not guarantee detection of all corrupted payload data.

For BT HV3 packets there is no simple way to determine if the payload data has been corrupted. BT HV3 packets do not support error correction for the payload, so a determination of whether the payload data is corrupted is difficult. Unlike HV1 and HV2 packets, HV3 packets to not include forward error correction. In addition, HV3 packets do not include a retransmit mechanism or CRC such as in eSCO packets. One way to reduce the effect of collisions between coexisting LTE TX and BT RX on the audio performance is to discard BT HV3 packets were at least a portion of the payload was received during, e.g., an LTE UL period and replace the discarded data with estimated payload data.

This may be accomplished using the high speed signaling between collocated LTE, BT, WLAN, BT/WLAN and/or other interfaces (or devices) of the communication device (or platform) 400 of FIG. 4. The timing of the collocated devices may be timing synchronized to allow alignment of the BT frames with the LTE frames. In this way, the start of the BT frames may be aligned relative to the LTE frames in such a way that the collisions are reduced or minimized. For example, when the BT interface (or device) 406 is operating as a collocated master, the BT interface 406 may control the alignment of the BT frames to minimize collisions with LTE TX. The BT interface 406 may also operate as a collocated slave with BT frame scheduling determined by a master device. While collisions with LTE TX may not be minimized, the collision correction may be implemented based upon the known BT and LTE scheduling. This may be applied to BT communications using HV3 or eSCO packets as illustrated in FIGS. 2 and 3. BT communications may also be synchronized with other coexisting communications (e.g., WiMax or WLAN) to reduce or minimize collisions with BT packets received by the BT device.

The BT interface (or device) 406 can determine if a BT packet is received during an LTE UL period based upon the information and signaling received from the LTE interface (or device) 403. If the BT packet was not received during an LTE UL period, then the payload may be assumed to be uncorrupted and processed to generate the audio output. In some implementations, the BT packet may be assumed to be corrupted if at least a portion of the BT packet was received during an LTE UL (or TX) period. The BT packet may be discarded and replaced by estimated payload data, which is used to generate the audio output. However, if the LTE device 403 is not transmitting while the BT HV3 packet is being received, uncorrupted packets may be unnecessarily discarded and the audio quality may be impacted.

FIG. 6 illustrates the effect of the reduced BER on the PESQ for each of the four LTE frame configurations of FIG. 2. Curve 603 corresponds to SA1-SSP5, curve 606 corresponds to SA1-SSP7, curve 609 corresponds to SA2-SSP5 and curve 612 corresponds to SA2-SSP7. Except where a very low BER exists, packet payload data with bit errors result in a lower PESQ that when the corrupted payload is replaced by the generated PLC data. The payload bit errors add “popcorn” noise to the audio output that is subjectively worse than the imperfect PLC results. For example, analysis has found that in some cases about 7 bit errors per HV3 payload (or about 3% BER) produce a PESQ that is about the same as the generated PLC data. This indicates that the packet BER may be used to determine whether a payload may be replaced by the generated PLC data.

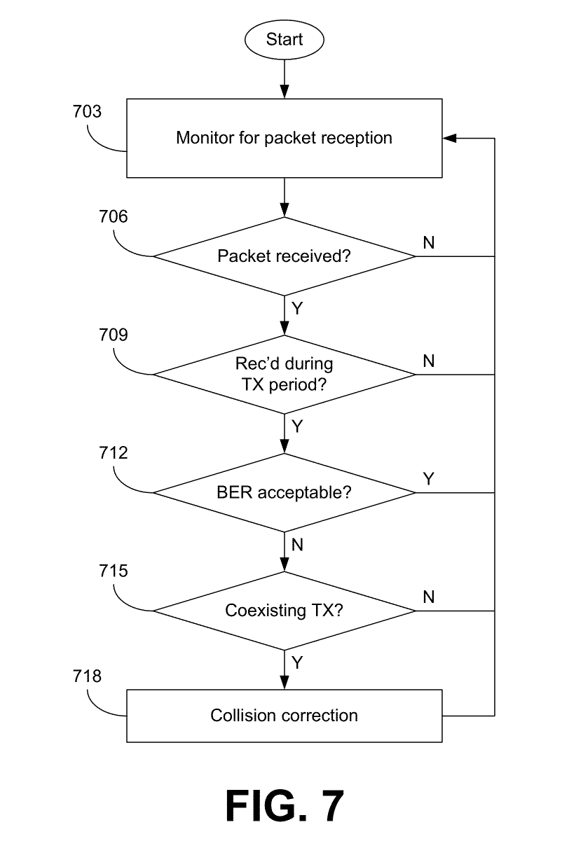

Referring to FIG. 7, shown is a flowchart illustrating an example of collision correction in accordance with various embodiments of the present disclosure. Beginning with 703, packet receptions are monitored by an interface (or device) of a communication device (or platform). For example, the BT interface (or device) 406 of FIG. 4 can monitor BT communications for BT packets being received during RX slots of BT frames. When a packet is received in 706, it is determined in 709 whether the packet was received during a transmission period of a coexisting interface (or device). For instance, the BT interface (or device) 406 may determine whether at least a portion of the BT packet was received during a coexisting LTE transmission (or UL) period. The determination may be based upon, e.g., the current LTE frame configuration, LTE frame synchronization signal, and BT schedule. If the packet was not received during a transmission period of the coexisting interface (or device), then the packet is processed and monitoring continues in 703, which are known by the BT interface 406. In some embodiments, when the packet is received during a TX period of the coexisting device, the packet payload may be replaced by estimated voice data generated by PLC in 718 which is used for the audio output.

In the example of FIG. 7, if the packet was received during a transmission period of the coexisting interface (or device) in 709, then the BER associated with the received packet is evaluated based upon a predefined threshold to determine if it is acceptable in 712. In some implementations, the BER may be estimated based upon, e.g., the known TX power of the coexisting interface (or device), the designed (or tested) isolation between the coexisting interfaces (or devices), filter characteristics, and/or temperature effects on the interfaces. Information such as the current TX power may be communicated from, e.g., the LTE interface 403 to the BT interface 406 through the signaling connection 409. In other embodiments, the BER may be determined by the receiving interface (or device) using measured values. In some cases, the BER may be determined based upon the weak signal counter of the receiving interface (or device). For example, BT uses phase shift keying (PSK) or Gaussian frequency-shift keying (GFSK) to code the contents of the packet payload. The weak signal counter examines the amount of symbol phase noise to determine whether a signal is weak or bad based upon evaluation thresholds. The weak signal counter indicates the number of signals in a received payload that were weak or bad. This may be used to determine an indication of how many bits in the payload are likely (e.g., with a probability of 40%) to contain an error. The relationship between the number of weak symbols indicated by the counter and the BER may be expressed as:

$$BER ≅ \frac{1}{n} {\sum }_{{n}_{packets}}^{ } \frac{1}{240} \cdot 40 \% \cdot 〈 \# weak symbols 〉$$

where n is the number of packets being evaluated.

Once the BER has been determined, it is compared to the predefined threshold in 712. If the BER is acceptable, then the packet is processed and monitoring continues in 703. For example, if the BER is equal to and/or below a BER threshold of 3% in 712, then the packet payload may be considered good. The packet may be considered to be corrupted if the BER is above the predefined threshold and good otherwise. In some embodiments, the packet payload may be replaced by estimated voice data generated by PLC in 718 and used for the audio output if the BER is unacceptable.

In the example of FIG. 7, if the BER is not acceptable in 712, then it is determined in 715 whether the coexisting interface (or device) was actually transmitting while the packet was being received. This may be determined based upon signaling provided to the receiving interface (or device) by the coexisting interface (or device). For example, the LTE interface (or device) 403 of FIG. 4 can provide a time advanced LTE TX signal to the BT interface (or device) 406 that indicates when the LTE interface transmissions are taking place. The signal may be time advanced by a predefined amount to allow the BT interface 406 to anticipate when the transmissions will occur. If the coexisting interface was not transmitting while the packet was being received, then the packet is processed and monitoring continues in 703. If the coexisting interface was transmitting while at least a portion of the packet was being received, then the packet payload may be replaced by estimated voice data generated by PLC to correct for corruption caused by collisions in 718. The PLC generated voice data is used for the audio output and monitoring continues in 703.

In some cases, only a portion of the packet payload may be corrupted as illustrated by the BT RX 213b of FIG. 2. Because of the alignment of the BT RX 213b and the LTE UL 216b, only the last 10 payload bytes were impaired by the LTE TX. In some implementations, the entire payload may be replaced by estimated PLC data. In other implementations, only the potentially corrupted portion of the BT packet payload may be replaced. For example, the last 10 bytes of the estimated PLC data may replace the last 10 bytes of the BT packet payload. By retaining the first 20 bytes of the original voice data, a better voice quality may be achieved in the reconstructed audio.

For example, if at least a portion of a BT HV3 packet was received during an LTE transmission frame, the BT interface (or device) 406 (FIG. 4) determines whether the LTE interface (or device) 403 was transmitting while a portion of the packet payload was being received. For instance, the BT device 406 may monitor the LTE TX signal from the LTE device 103. If the LTE TX signal indicates that LTE transmission occurs while the payload of the BT packet is being received, then the packet payload may be discarded by the BT interface 406 and replace by estimated payload data, which is used to generate the audio output. If the LTE TX signal indicates that there is no LTE transmission while the payload of the BT packet is being received, then the packet payload may be assumed to be uncorrupted and processed to generate the audio output.

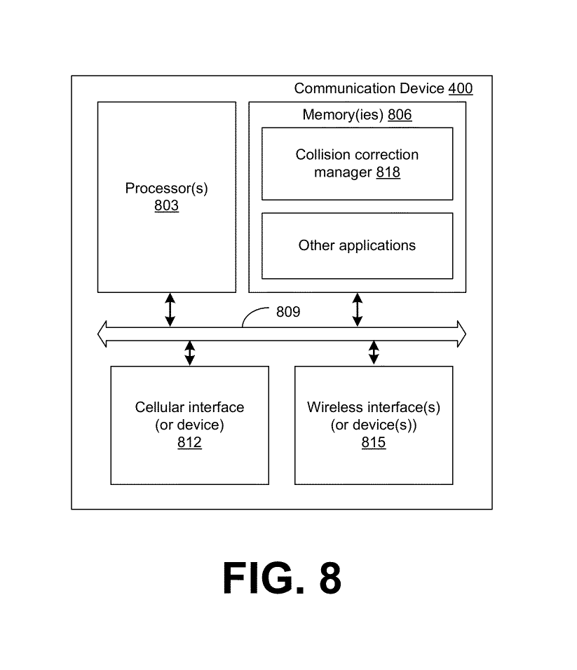

With reference to FIG. 8, shown is a schematic block diagram of an example of the communication device 400 in accordance with various embodiments of the present disclosure. The communication device 400 includes at least one processor circuit, for example, having a processor 803 and a memory 806, both of which are coupled to a local interface 809. The communication device 400 may include a cellular interface (or device) 812 such as, e.g., the LTE interface (or device) 403 of FIG. 4 and one or more wireless interface (or device) 815 including, e.g., the BT interface (or device) 406 of FIG. 4, all of which may be coupled to the local interface 409. The cellular interface (or device) 812 comprises processing circuitry for supporting cellular communications such as, e.g., LTE, 2G, 3G, 4G, WiMAX, WCDMA, HSDPA, or other wireless communication protocols. The wireless interface(s) (or device(s)) 815 comprise processing circuitry for supporting wireless communications such as, e.g., Bluetooth (BT), IEEE 802.11a/b/g/n, near field communication (NFC), global positioning system (GPS)/global navigation satellite system (GNSS), and/or other wireless communication protocols.

In various embodiments, the processing circuitry is implemented as at least a portion of a microprocessor. The processing circuitry may be implemented using one or more circuits, one or more microprocessors, application specific integrated circuits, dedicated hardware, digital signal processors, microcomputers, central processing units, field programmable gate arrays, programmable logic devices, state machines, or any combination thereof. In yet other embodiments, the processing circuitry may include one or more software modules executable within one or more processing circuits. The processing circuitry may further include memory configured to store instructions and/or code that causes the processing circuitry to execute data communication functions. In some cases, portions of the cellular interface (or device) 812 and/or wireless interface(s) (or device(s)) 815 may be implemented by processor 803 via local interface 809. The local interface 809 may comprise, for example, a data bus with an accompanying address/control bus or other bus structure as can be appreciated.

Stored in the memory 806 are both data and several components that are executable by the processor 803 and/or by processing circuitry of the cellular interface (or device) 812 and/or wireless interface(s) (or device(s)) 815. In particular, stored in the memory 806 and executable by the processor 803 may be a collision correction manager 818, and potentially other applications. In addition, an operating system may be stored in the memory 806 and executable by the processor 803. In some embodiments, the cellular interface (or device) 812 and/or wireless interface(s) (or device(s)) 815 may include memory for storing the collision correction manager 818. In some cases, the processor 803 and memory 806 may be integrated as a system-on-a-chip.

It is understood that there may be other applications that are stored in the memory and are executable by the processor 803, the cellular interface (or device) 812 and/or wireless interface(s) (or device(s)) 815 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory and are executable by the processor 803, the cellular interface (or device) 812 and/or wireless interface(s) (or device(s)) 815. In this respect, the term “executable” means a program file that is in a form that can ultimately be run by the processor 803, the cellular interface (or device) 812 and/or wireless interface(s) (or device(s)) 815. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and the memory 806 may represent multiple memories 806 that operate in parallel processing circuits, respectively. In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the collision correction manager 818, and other various systems described herein may be embodied in software or code executed by general purpose hardware, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 7 shows the functionality and operation of an implementation of portions of the collision correction manager 818 and logic implemented by the cellular interface (or device) 812 and/or wireless interface(s) (or device(s)) 815. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowchart of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. Further, in some embodiments, one or more of the blocks shown in FIG. 7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the collision correction manager 818 that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method, comprising:
determining whether a payload of a packet is received by a first communication interface during a transmission period of a second collocated interface based at least in part upon signaling from the second collocated interface; and
replacing at least a portion of the payload of the packet with estimated payload data based at least in part upon a determination that the payload was received during the transmission period.

2. The method of claim 1, wherein the packet is received by a Bluetooth (BT) interface.

3. The method of claim 2, wherein the packet is an HV3 voice packet.

4. The method of claim 1, wherein the second collocated interface supports long term evolution (LTE) cellular communications.

5. The method of claim 4, wherein the signaling comprises an LTE frame synchronization signal and LTE frame configuration information.

6. The method of claim 1, further comprising:
determining whether reception of at least a portion of the payload occurs during a transmission by the cellular interface based upon the signaling from the cellular interface; and
replacing the at least a portion of the payload of the packet with corresponding estimated payload data when the at least a portion of the payload is received during a transmission by the cellular interface.

7. The method of claim 6, wherein the signaling comprises an LTE transmit signal.

8. The method of claim 1, wherein the estimated payload data is provided by a packet loss concealment (PLC) algorithm.

9. A communication device, comprising:
a first interface configured to support Bluetooth (BT) communications; and
a second interface collocated with the first interface, the second interface configured to communicate with the first interface; and
where the first interface is further configured to replace at least a portion of a payload of a BT packet with estimated payload data based at least in part upon signaling from the second interface, the signaling indicating that at least a portion of the BT packet was received by the first interface during a transmission period of the second interface.

10. The communication device of claim 9, wherein the second interface is a cellular interface.

11. The communication device of claim 10, wherein the cellular interface supports long term evolution (LTE) cellular communications.

12. The communication device of claim 9, wherein the signaling comprises an LTE frame synchronization signal and LTE frame configuration information.

13. The communication device of claim 9, wherein the first interface is configured to replace the at least a portion of the payload with corresponding estimated payload data based at least in part upon a bit error rate (BER) associated with the BT packet.

14. The communication device of claim 9, wherein the first interface is configured to replace the at least a portion of the payload with corresponding estimated payload data in response to the at least a portion of the payload being received during a transmission by the second interface.

15. The communication device of claim 9, wherein the entire payload of the BT packet is replaced with the estimated payload data.

16. The communication device of claim 9, wherein the estimated payload data is artificial speech based upon prediction.

17. A non-transitory computer readable medium having a program, that when executed by a processing circuitry, causes the processing circuitry to:
determine whether a payload of a Bluetooth (BT) packet is received by a communication interface during a transmission period of a collocated cellular interface based at least in part upon signaling from the cellular interface; and
replace at least a portion of the payload of the BT packet with estimated payload data based at least in part upon a determination that the payload was received during the transmission period.

18. The non-transitory computer readable medium of claim 17, wherein replacing the at least a portion of the payload of the BT packet is based at least in part upon a comparison of a bit error rate (BER) associated with the BT packet with a predefined threshold.

19. The non-transitory computer readable medium of claim 17, wherein replacing the at least a portion of the payload of the BT packet is based at least in part upon at least a portion of the BT packet being received during a transmission by the cellular interface.

20. The non-transitory computer readable medium of claim 19, wherein the at least a portion of the payload was received during the transmission by the cellular interface.
